(19) United States
(12) Patent Application Publication
(10) Pub. No.: US 2008/0235017 A1
(43) Pub. Date: Sep. 25, 2008

(54) VOICE INTERACTION DEVICE, VOICE INTERACTION METHOD, AND VOICE INTERACTION PROGRAM

(75) Inventor: Masashi SATOMURA, Wako-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/053,755

(22) Filed: Mar. 24, 2008

(30) Foreign Application Priority Data
Mar. 22, 2007 (JP) 2007-075351

(51) Int. Cl. G10L 15/00

(52) U.S. Cl. 704/246; 704/E15.04

(57) ABSTRACT

The present invention provides a voice interaction device capable of performing an interaction meeting any demand from a user at proper time in flexible response to a circumferential condition of the user, a voice interaction method and a voice interaction program thereof. The voice interaction device controls the interaction with the user in response to an input voice from the user, including an available time calculation unit (32) which calculates an available period of time for interaction with the user based on the circumferential condition of the user, and an interaction control unit (31) which controls the interaction based on at least the available period of time for interaction calculated by the available time calculation unit (32).

### BACKGROUND OF THE INVENTION

1. Field of the Invention

The present invention relates to a voice interaction device which controls an interaction in response to a voice input from a user, a voice interaction method, and a voice interaction program causing a computer to execute processes of the voice interaction device.

2. Description of the Related Art

In recent years, there has been used a voice interaction device which performs operation of apparatus and information supply or the like to a user by recognizing input voice from the user. This type of voice interaction device interacts with a user by recognizing voice (speech) from the user and responds (outputs a voice guide) to the user based on a recognition result of the voice to prompt the user the next speech, and performs operation of apparatus and information supply or the like to the user based on the recognition result of the interaction with the user. The voice interaction device is disposed for example on a vehicle for the user to operate a plurality of apparatuses such as an audio system, a navigation system, an air conditioner and the like mounted to the vehicle.

For this type of voice interaction device, there has been known one which obtains, as the input voice, spontaneous speech from the user including unnecessary words other than instruction words for operation of apparatus or the like, a paraphrase, and a temporary halt. However, the user may temporarily halt his/her speech, or may cancel it midway of his/her speech in the spontaneous speech. Thereby, there has been disclosed a voice interaction device which makes an appropriate response by detecting the completion of a speech even though the user cancels his/her speech midway (for example refer to Japanese Patent Laid-open No. H6-202689, hereinafter referred to as Patent Document 1).

The voice interaction device according to Patent Document 1 recognizes the input voice as a word sequence by the use of a phonologic model or a non-voice model for determining acoustic features of a speech, a dictionary for determining words contained in the speech according to the acoustic features, and speech grammar for determining the order of words contained in the speech, and outputs the meaning thereof. In the voice interaction device, a predefined duration is set with respect to a position possible to have a halt in speech respectively in the speech grammar. Thus when performing voice recognition, the voice interaction device determines the completion of speech if the halt in speech is longer than or equal to the preset duration and outputs the recognition result of the speech until the speech had halted. Thereafter, the voice interaction device delivers a response via voice synthesis based on the output recognition result of the speech.

By the way, a user may change his/her demand according to specific circumstances in the interaction. For example, if the user is a vehicle driver, he/she may change his/her demand according to driving conditions (a road where a vehicle is driving, the vehicle and driver's state or the like). Specifically, in the case where there is no enough available time for an interaction in a high speed driving, it is desirable to perform the interaction shortly and briefly, and it is even necessary to stop the interaction so that the driver may concentrate on driving. Further, when a user is not accustomed to interacting with the interaction device for example, it is desired that detailed audio guide should be output slowly. While on the other hand, when a user is well accustomed to interacting with the device, it is desired that short audio guide should be output briefly in a fast speed to avoid a redundant interaction. Thereby, it is necessary to perform interaction in flexible response to any kind of demand from a user.

However, the interaction device according to Patent Document 1 performs interaction with the user regardless of the user's conditions. In other words, since the user's conditions, such as whether the user wants to have a brief interaction in short time, or whether the user has enough available time, have not been taken into account, there exists a possibility that the interaction may not be performed with good efficiency to meet the user's demand. Furthermore, the device according to Patent Document 1 outputs a response based on the speech before the time when the speech from the user or the interaction was cancelled, and as a result of this, the interaction becomes insufficient. Accordingly, a proper recognition result may not be obtained and therefore operation of apparatus and information supply or the like to the user may not be appropriately performed. Thereby, it is difficult for the voice interaction device disclosed in Patent Document 1 to perform interaction in flexible response to the user's conditions.

### SUMMARY OF THE INVENTION

The present invention has been accomplished in view of the aforementioned matters, and it is therefore an object of the present invention to provide a voice interaction device capable of performing a proper time interaction in flexible response to a user's condition and a voice interaction method, and a voice interaction program causing a computer to execute processes of the interaction device.

The voice interaction device of the present invention for controlling an interaction in response to a voice input from a user includes an available time calculation unit which calculates an available period of time for interaction with the user based on a circumferential condition of the user, and an interaction control unit which controls interaction based on at least the available period of time for interaction calculated by the available time calculation unit (first invention).

In the voice interaction device of the first invention, an output to the user is determined by the interaction control unit based on a recognition result on the voice input from the user, and a next voice input is provided by the user according the output to carry out the interaction with the user. Hereby, operation of apparatus and information supply or the like to the user are performed via the interaction.

Herein, available time that the user may spend on the interaction may vary according to the circumferential condition of the user, thus the available time calculation unit calculates the available period of time for interaction with the user based on the user's circumferential condition. Here, the available period of time for interaction is a span of time which is supposed to be possible to spend on the interaction with the device by the user with respect to the user's available time. The interaction control unit then controls the interaction according to the available period of time for interaction. Thereby, it is possible to determine a locution or speed for a response to be output, for example, by adjusting information contained in the output or the amount thereof so that the available period of time may cover the entire interaction. According to the present invention, it is possible to perform interaction in flexible response to any demand from a user.

Further, in the voice interaction device of the first invention, the user is an occupant of a vehicle; the voice interaction device is mounted to the vehicle and further includes a driving condition detection unit which detects a driving condition of the vehicle; and the available time calculation unit employs the driving condition detected by the driving condition detection unit as the circumferential condition of the user to calculate the available period of time for interaction with the user (second invention).

In other words, in the case where the user is an occupant, for example the driver of the vehicle, the available time for the interaction according to the driving condition may be different. Accordingly, by performing the interaction in response to the available period of time which is calculated out based on the driving condition detected by the driving condition detection unit, it is possible to perform the interaction satisfying the user's desire in appropriate time.

In the voice interaction device of the second invention, it is preferable that the driving condition include at least one of information concerning a road on which the vehicle's driving, information concerning driving state of the vehicle, and information concerning operation state of apparatuses mounted to the vehicle (third invention).

Herein, the information concerning the road on which the vehicle's driving refers to, for example, type, width and speed limit of a road. The information concerning driving state of the vehicle includes, for example, running speed, running time-of-day, inter-vehicular distance, waiting time for the traffic lights of the vehicle and a distance from the vehicle to a specific location on the road. In addition, the specific location refers to a location where attention should be paid in driving such as an intersection, a railroad crossing or the like. The information concerning operation state of apparatuses mounted to the vehicle refers to operation frequency of the apparatuses by the user, the numbers and types of apparatus being operated currently, or the like.

The information corresponding to the driving condition of the vehicle is related to available time for the driver of the vehicle or the like. In other words, for example in the case where the vehicle is running at a high speed or the vehicle is approaching to an interaction, it is considerable that the driver or the like should have less available time. Thereby, based on the information, it is possible to calculate the available period of time for interaction in response to the circumferential condition of the user.

It is preferred that the voice interaction device of the first invention further include a user feature detection unit which detects the feature of the user interacting with the voice interaction device, and the interaction control unit controls interaction based on the feature of the user detected by the user feature detection unit (fourth invention).

Since the user's demand on interaction varies according to the feature, such as preferences, a level of proficiency or the like, of the user who is involved in the interaction, the feature of the user is detected by the user feature detection unit and the interaction control unit controls the interaction in response to the feature of the user. As a result, by adjusting the information contained in the output and the amount thereof in response to the available period of time for interaction and further the feature of the user, it is possible to determine a locution or speed for a response sentence to be output; and accordingly, possible to perform interaction meeting the user's demand further.

In the voice interaction device of the fourth invention, it is preferable that the user feature detection unit detects the feature of the user based on an interaction history between the voice interaction device and the user (fifth invention).

Here, from the history of the interaction that the user has performed, the user feature detection unit detects, for example, the frequency of the interaction that the user has performed concerning operations of a certain apparatus, time spent on the interaction, recognition degree of input voice with respect to the interaction. Accordingly, based on those results detected, it is possible to know properly the feature of the user, such as the user's preferences and a level of proficiency or the like regarding the interaction.

In the voice interaction device of the fourth invention, the user feature detection unit detects a level of proficiency of the interaction between the voice interaction device and the user as the feature of the user (sixth invention).

In the case, for example, where a user who is not accustomed to interaction with the device has a poor level of proficiency, it is preferred to carry out an audio guide in detail slowly. While on the other hand, when a user who is good at interacting with the device has a better level of proficiency, it is desired that a short audio guide should be given briefly in a fast speed to avoid a redundant interaction. Therefore, by detecting the level of proficiency as the feature of the user and performing interaction control by the interaction control unit according to the detection result, it is possible to determine a locution or speed for a response to be output by adjusting the information contained in the output and the amount thereof with respect to the available period of time for interaction and further the level of proficiency of the user; and accordingly, possible to perform interaction meeting the user's demand furthermore.

In the voice interaction device of the first invention, the voice interaction device further includes an importance judging unit which judges importance of information output to the user under interaction control by the interaction control unit, and the interaction control unit controls interaction based on a judging result from the importance judging unit (seventh invention).

The importance of information, in other words, refers to degree of necessity or urgency of information to a user. For example when a vehicle is approaching to an intersection, it is considered that information concerning the intersection would be of higher importance to a driver among traffic information. It is also considerable that information such as accident information or the like would be of higher importance to the driver in comparison to information regarding weather and normal traffic congestion, for example. Since the importance of information to be output to the user is judged by the importance judging unit according to the seventh invention, it is possible to determine the information and the amount thereof so as to output information with higher importance by priority for example, when performing the interaction control. Thereby, it is possible to perform interaction meeting the user's demand furthermore.

The present application also discloses a voice interaction method which controls an interaction in response to a voice input from a user, includes an available time calculation step of calculating an available period of time for interaction with the user based on a circumferential condition of the user, and an interaction control step of controlling interaction based on at least the available period of time for interaction calculated in the available time calculation step (Eighth invention).

According to the voice interaction device of the eighth invention, as what has been described with regard to the voice interaction device of the first invention, the available period of time for interaction is calculated in the available time calculation step on the basis of the circumferential condition of the user, and thereby it is possible to determine a locution or speed for a response to be output, for example by adjusting information contained in the output or the amount thereof in the interaction control step so that the available period of time for interaction may cover the entire interaction. According to the present invention, it is possible to perform interaction in flexible response to any demand from the user.

The present application further discloses a voice interaction program causing a computer to execute processes of controlling an interaction in response to a voice input from a user, has function to cause the computer to execute: an available time calculation process of calculating an available period of time for interaction with the user based on a circumferential condition of the user, and an interaction control process of controlling interaction based on at least the available period of time for interaction calculated in the available time calculating process (Ninth invention).

According to the voice interaction program of the ninth invention, it is possible to execute in a computer processes which will achieve effects described in the first invention.

### BRIEF DESCRIPTION OF THE DRAWINGS

FIG. 1 is a functional block diagram of a voice interaction device according to an embodiment of the present invention.

FIG. 2 is an explanatory diagram illustrating the configurations of a language model and a parsing model of the voice interaction device illustrated in FIG. 1.

FIG. 3 is a flow chart illustrating an overall operation (voice interaction process) of the voice interaction device illustrated in FIG. 1.

FIG. 4 is an explanatory diagram illustrating a voice recognition process with the language model in the voice interaction process illustrated in FIG. 3.

FIG. 5 is an explanatory diagram illustrating a parsing process with the parsing model in the voice interaction process illustrated in FIG. 3.

FIG. 6 is an explanatory diagram illustrating forms used in a determination process of scenarios in the voice interaction process illustrated in FIG. 3.

FIG. 7 is a flow chart illustrating a calculation process for an available period of time for interaction in the voice interaction process illustrated in FIG. 3.

FIG. 8 is an explanatory diagram illustrating the determination process of scenarios in the voice interaction process illustrated in FIG. 3.

FIG. 9 is a diagram illustrating an interaction example in the voice interaction process illustrated in FIG. 3.

FIG. 10 is a diagram illustrating another interaction example in the voice interaction process illustrated in FIG. 3.

FIG. 11 is a diagram illustrating another interaction example in the voice interaction process illustrated in FIG. 3.

### DETAILED DESCRIPTION OF THE PREFERRED EMBODIMENTS

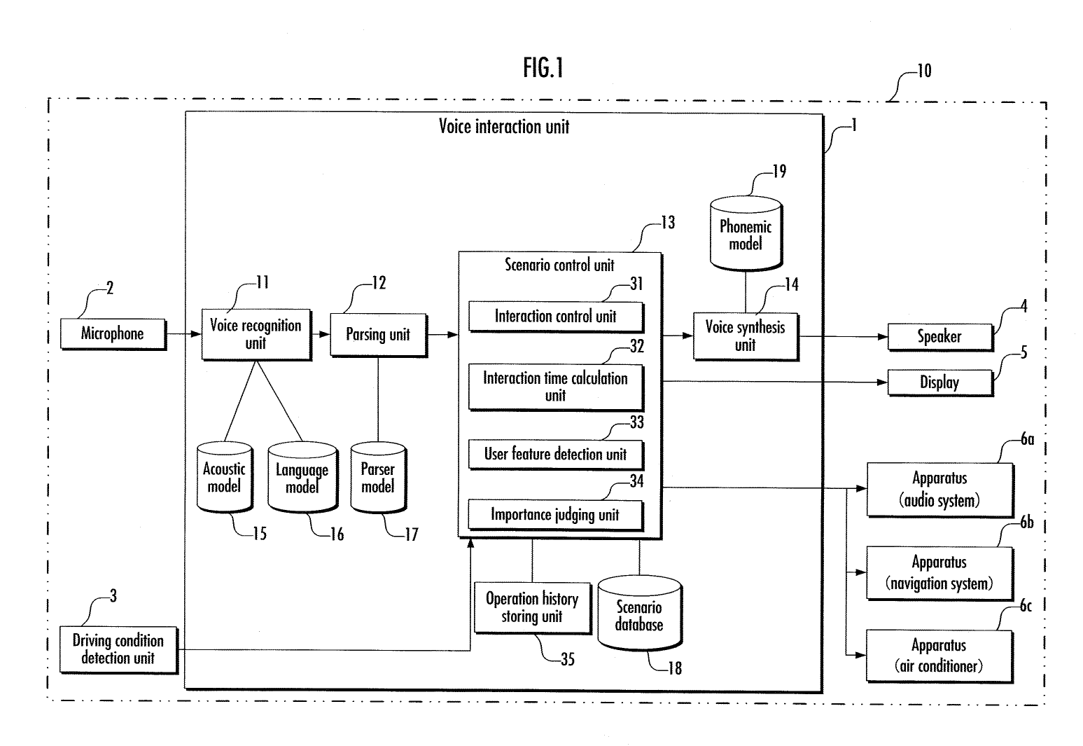

As illustrated in FIG. 1, the voice interaction device according to one embodiment of the present invention consists of a voice interaction unit 1 and is mounted to a vehicle 10. The voice interaction unit 1 is connected with a microphone 2 to which speech from a driver is input, a driving condition detection unit 3 that detects a state of the vehicle 10, a speaker 4 which outputs a response to the driver, a display 5 which provides information display to the driver, and a plurality of apparatuses 6a to 6c which can be operated by the driver via voice or the like.

The microphone 2, to which voice of the driver of the vehicle 10 is input, is disposed in a predefined position in the vehicle. When initiation of voice input is instructed from the driver by operating for example a talk switch, the microphone 2 obtains the input voice as the speech of the driver. The talk switch is an ON/OFF switch which may be operated by the driver of the vehicle 10, and the initiation of voice input is instructed by pressing the talk switch to ON.

The driving condition detection unit 3 is a sensor or the like for detecting the state of the vehicle 10. Herein, the state of the vehicle 10 refers to, for example, running conditions of the vehicle 10 such as speed, acceleration and deceleration; driving conditions about position and running road or the like of the vehicle 10; a working state of an apparatus (a wiper, a blinker, an audio system, a navigation system, or the like) mounted to the vehicle 10. In detail, for example, a vehicle speed sensor detecting the running speed of the vehicle 10 (vehicle speed), a yaw rate sensor detecting yaw rate of the vehicle 10, a brake sensor detecting brake operations of the vehicle 10 (whether a brake pedal is operated or not), or a radar detecting a preceding vehicle or the like may serve as the sensor detecting the running state of the vehicle 10. Furthermore, an interior state such as inner temperature of the vehicle 10, and a driver's state of the vehicle 10 (palm perspiration, driving load or the like of the driver) may be detected as the state of the vehicle 10.

The speaker 4 outputs a response (an audio guide) to the driver of the vehicle 10. A speaker included in an audio system 6a which will be described hereinafter may serve as the speaker 4.

The display 5 is, for example, a head up display (HUD) displaying information such as an image on a front window of the vehicle 10, a display provided integrally with a meter for displaying the running conditions of the vehicle 10 such as speed, or a display provided in a navigation system 6b which will be described hereinafter. In the present embodiment, the display of the navigation system 6b is a touch panel having a touch switch mounted therein.

The apparatuses 6a to 6c in detail are the audio system 6a, the navigation 6b and an air conditioner 6c, which are mounted to the vehicle 10. For each of the apparatuses 6a to 6c, there are provided predefined controllable elements (devices, contents or the like), functions and operations.

The audio system 6a is provided with a CD player, a MP3 player, a radio, a speaker or the like as its devices. The audio system 6a has “sound volume” and others as its functions, and “change”, “on”, “off” and others as its operations. Further, the operations of the CD player and MP3 player include “play”, “stop” and others. The functions of the radio include “channel selection” and others. The operations related to “sound volume” include “up”, “down” and others.

The navigation system 6b has “image display”, “route guidance”, “POI search” and others as its contents. The operations related to the image display include “change”, “zoom in”, “zoom out” and others. The route guidance is a function to guide a user to a destination via an audio guide or the like. The POI search is a function to search for a destination such as a restaurant or a hotel.

The air conditioner 6c has “air volume”, “preset temperature” and others as its functions. Furthermore, the operations of the air conditioner 6c include “on”, “off” and others. The operations related to the air volume and preset temperature include “change”, “up”, “down” and others.

These apparatuses 6a to 6c are respectively controlled by designating the information (type of the apparatus or function, content of the operation, or the like) for controlling an object. The devices, contents and functions of each of the apparatuses 6a to 6c as the operational objects are categorized into a plurality of domains. The term “domain” is a classification representing a category corresponding to contents of an object to be recognized, in particular, the term “domain” refers to the operational object such as an apparatus or function. The domains may be designated in a hierarchical manner; for example, the “audio” domain is classified into sub-domains of “CD player” and “radio”.

The voice interaction unit 1, a detailed illustration thereof in figure is omitted, is an electronic unit that has an A/D conversion circuit converting input analog signals to digital signals, a memory storing voice data, and a computer (an arithmetic processing circuit having a CPU, a memory, an input/output circuit and the like, or a microcomputer having those functions aggregated therein) which has an interface circuit for accessing (reading and writing) the voice data stored in the memory and performs various arithmetic processes on the voice data. In addition, the memory in the computer or an external storage medium may be used as a memory for storing voice data.

An output (analog signals) from the microphone 2 is input to the voice interaction unit 1 and is converted by the A/D conversion circuit to digital signals. The voice interaction unit 1 performs a recognition process on speech from the driver on the basis of the input data, and thereafter based on a recognition result of the recognition process, the voice interaction unit 1 performs processes like interacting with the driver, providing information to the driver via the speaker 4 or the display 5, or controlling the apparatuses 6a to 6c.

These processes may be implemented when a program pre-installed in the memory of the computer is executed by the computer. The program includes a voice interaction program of the present invention. In addition, it is preferable for the program to be stored in the memory via a recording medium, for example a CD-ROM or the like. It is also possible for the program to be distributed or broadcast from an external server via a network or satellite and received by a communication apparatus mounted to the vehicle 10 and then stored in the memory.

More specifically, the voice interaction unit 1 includes as the functions implemented by the above program, a voice recognition unit 11 which uses an acoustic model 15 and a language model 16 to recognize the input voice and output the recognized input voice as a recognized text, a parsing unit 12 which uses a parser model 17 to comprehend from the recognized text the meaning of the speech, a scenario control unit 13 which uses a scenario database 18 to determine a scenario based on a control candidate identified from the recognition result of the speech and responds to the driver or controls the apparatus or the like, and a voice synthesis unit 14 which synthesizes a voice response to be output to the driver by using a phonemic model 19. Herein, a control candidate is equivalent to an operational object candidate or an operational content candidate identified from the recognition result of the speech.

More specifically, the scenario control unit 13 includes an available time calculation unit 32, a user feature detection unit 33, an importance judging unit 34, and an interaction control unit 31 as its functions. The available time calculation unit 32 calculates an available period of time for interaction with the driver based on the detection result by the driving condition detection unit 3. The user feature detection unit 33 detects the features of the driver based on an operation history stored in an operation history storing unit 35. The importance judging unit 34 judges importance degree of information contained in a response to be output. The interaction control unit 31 controls an interaction on the basis of the available period of time for interaction, the user's features and the importance of information.

Each of the acoustic model 15, the language model 16, the parser model 17, the scenario database 18 and the phonemic model 19 is a recording medium (database) such as a CD-ROM, DVD, HDD and the like having data recorded thereon.

The operation history storing unit 35 is stored with histories concerning operational objects and operational contents (operation history). Specifically, each of the operational contents performed by the driver with respect to the apparatuses 6a to 6c is stored in the operation history storing unit 35 together with the date and time of the respective operation. Thus, it is possible to know the operation frequency, operation times and others that a driver has performed to each of the apparatuses 6a to 6c.

The voice recognition unit 11 performs a frequency analysis on waveform data indicating the voice of the speech input to the microphone 2 and extracts a feature vector. Thereby, the voice recognition unit 11 carries out a voice recognition process in which it recognizes the input voice based on the extracted feature vector and outputs the recognized input voice as a text expressed by a series of words. Herein, the term “text” refers to a meaningful syntax which is expressed with a series of words and has predefined designations. The voice recognition process is performed through comprehensive determination of the acoustic and linguistic features of the input voice, by using a probability and statistical method which will be described hereinafter.

In other words, the voice recognition unit 11 firstly uses the acoustic model 15 to evaluate the likelihood of each phonetic data corresponding to the extracted feature vector (hereinafter, this likelihood of phonetic data will be referred to as “sound score” where appropriate), to determine the phonetic data according to the sound score. Further, the voice recognition unit 11 uses the language model 16 to evaluate the likelihood of each text expressed with a series of words corresponding to the determined sound data (hereinafter, this likelihood of text will be referred to as “language score” where appropriate), to determine the text according to the language score. Furthermore, the voice recognition unit 11 calculates a confidence factor of voice recognition for every one of the determined texts based on the sound score and the language score of the text (hereinafter, this confidence factor will be referred to as “voice recognition score” where appropriate). The voice recognition unit 11 then outputs as a recognized text any text expressed by a series of words having voice recognition score fulfilling a predefined condition.

The parsing unit 12, using the parser model 17, performs a parsing process to comprehend the meaning of the input speech from the recognized text which has been recognized by the voice recognition unit 11. The parsing process is performed by analyzing the relation between words (syntax) in the recognized text by the voice recognition unit 11, by using a probability and statistical method which will be described hereinafter.

In other words, the parsing unit 12 evaluates the likelihood of the recognized text (hereinafter the likelihood of recognized text will be described as “parsing score” where appropriate), and determines a text categorized into a class corresponding to the meaning of the recognized text based on the parsing score. Then, the parsing unit 12 outputs the categorized text having the parsing score fulfilling a predefined condition as a control candidate group identified based on the recognition result of input speech, together with the parsing score. Herein, the term “class” corresponds to the classification according to the category representing the operational object or the operational content, like the domain described above. For example, when the recognized text is “change of setting”, “change the setting”, “modify the setting”, or “setting change”, the categorized text will be {Setup} for any of them.

The scenario control unit 13 uses the data recorded in the scenario database 18 to determine a scenario for a response output to the driver or for controlling the apparatus, based on the identified control candidate and the state of the vehicle 10 obtained from the driving condition detection unit 3. The scenario database 18 is recorded preliminarily therein with a plurality of scenarios for the response output or apparatus control together with the control candidate or the state of the vehicle. The scenario control unit 13 performs the control process of a voice response or an image display, or the control process for an apparatus. More specifically, for a voice response for example, the scenario control unit 13 determines the content of the response to be output (a response sentence for prompting the driver a next speech, or a response sentence for informing the user of completion of an operation or the like), and speed or sound volume for outputting the response.

In the scenario control unit 13 in this case, the available time calculation unit 32 sets the available period of time for interaction to three phases categorized into “long”, “middle” and “short” based on the detection value obtained from the driving condition detection unit 3; the user feature detection unit 33 sets the features of the driver (referred to level of proficiency and operation experience in the present embodiment) to three phases categorized into “better”, “good” and “poor” according to the operation history stored in the operation history storing unit 35; and the importance judging unit 34 sets the importance of information concerning the controls identified from the recognition result of the input speech to three phases categorized into “high”, “moderate” and “low”. In detail, the importance judging unit 34 retrieves an importance of information from a database having information preliminarily registered with importance, and judges the importance of information by adjusting the importance of information according to the recognition result of the input speech, the detection value obtained from the driving condition detection unit 3, and the features of the driver detected by the user feature detection unit 33.

Thereafter, the interaction control unit 31 determines information contained in a response to be output so as to output information with high importance on the basis of the importance of information by priority.

The voice synthesis unit 14 synthesizes voice using the phonemic model 19 in accordance with the response sentence determined in the scenario control unit 13, and outputs it as the waveform data indicating the voice. The voice is synthesized using the processing of TTS (Text to Speech), for example. More specifically, the voice synthesis unit 14 normalizes the text of the response sentence determined by the scenario control unit 13 to an expression suitable for the voice output, and converts each word in the normalized text into phonetic data. The voice synthesis unit 14 then determines a feature vector from the phonetic data using the phonemic model 19, and performs a filtering process on the feature vector for conversion into waveform data. The waveform data is output from the speaker 4 as the voice.

The acoustic model 15 is recorded therein with data indicating probabilistic correspondence between the data and the feature vector. In detail, the acoustic model 15 is provided with a plurality of models corresponding respectively to recognized units (such as phoneme, morpheme or word). As the acoustic model, Hidden Markov Model (HMM) is generally known. HMM is a statistical signal source model that represents voice as a variation of a stationary signal source (state) and expresses it with a transition probability from one state to another. With HMM, it is possible to express an acoustic feature of the voice changing in a time series with a simple probability model. The parameters of HMM such as the transition probability or the like are predetermined through training by providing corresponding voice data for learning. The phonemic model 19 is also recorded therein with the same HMM parameters as those in the acoustic model 15 for determining the feature vector from the phonetic data.

The language model 16 is recorded therein with data indicating an appearance probability and a connection probability of a word acting as a recognition object, together with the phonetic data and text of the word. The word as the recognition object is preliminarily determined to be likely used in the speech for controlling an object. The appearance probability and connection probability of a word are generated statistically by analyzing a large volume of training text corpus. For example, the appearance probability of a word is calculated based on the appearance frequency of the word in training text corpus.

For the language model 16, a language model of N-gram for example is used. The N-gram language model expresses a specific N numbers of words that appear consecutively with a probability. In the present embodiment, the N-grams corresponding to the number of words included in the voice data are used as the language model 16. For example, in a case where the number of words included in the voice data is two, a uni-gram (N=1) expressed as an appearance probability of one word, and a bi-gram (N=2) expressed as an occurrence probability (i.e., a conditional appearance probability for the preceding word) of a series of two words, or a two-word sequence are used.

In addition, N-grams may be used for the language model 16 by restricting the N value to a predefined upper limit. For example, a predefined value (for example, N=2), or a value set successively so that the process time for the input speech is within a predefined time may be used as the predefined upper limit. For example, when the N-grams having N=2 as the upper limit is used, only the uni-gram and the bi-gram are used even if the number of words included in the phonetic data is greater than two. As a result, it is possible to prevent the arithmetic cost for the voice recognition process from becoming too much, and thus to output a response to the speech from the driver in an appropriate response time.

The parser model 17 is recorded therein with data indicating an appearance probability and a connection probability of a word as a recognition object, together with the text and class of the word. For example, the language model of N-grams may be used in the parser model 17, as in the case of the language model 16. In the present embodiment, specifically, the N-grams having N=3 as the upper limit where N is not greater than the number of words included in the recognized text are used in the parser model 17. That is to say, for the parser model 17, a uni-gram a bi-gram and a tri-gram (N=3) expressed as an occurrence probability of a series of three words, that is to say a three-word sequence (i.e., a conditional appearance probability for the preceding two words) are used. It should be noted that the upper limit may be set arbitrarily and is not restricted to three. It is also possible to use the N-grams having N value not greater than the number of words included in the recognized text, without restricting the upper limit.

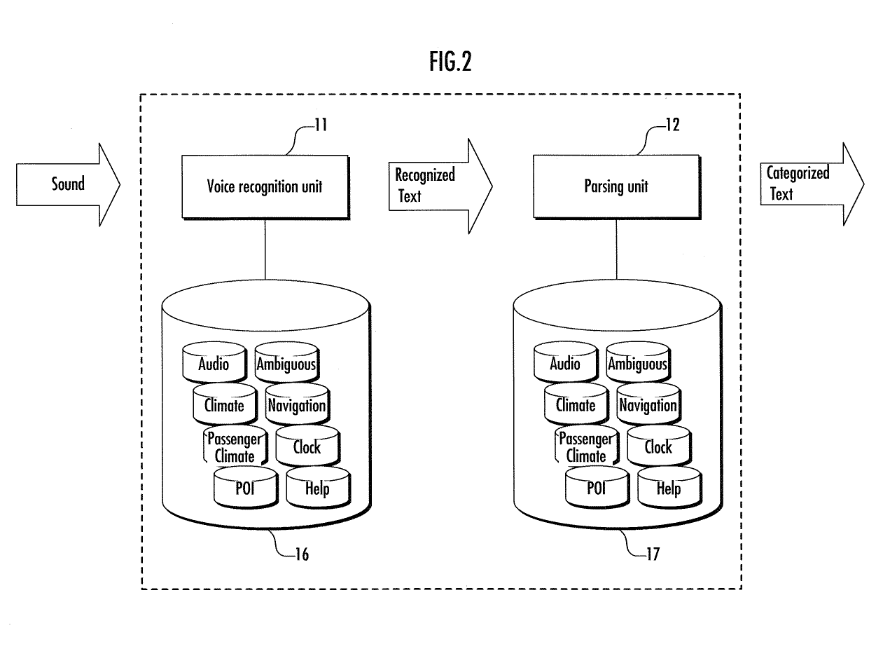

As illustrated in FIG. 2, the language model 16 and the parser model 17 have data categorized into domain types, respectively. In the example illustrated in FIG. 2, the domain types includes eight types of {Audio}, {Climate}, {Passenger Climate}, {POI}, {Ambiguous}, {Navigation}, {Clock} and {Help}. {Audio} indicates that the operational object is the audio system 6a. {Climate} indicates that the operational object is the air conditioner 6c. {Passenger Climate} indicates that the operational object is the air conditioner 6c at the passenger seat. {POI} indicates that the operational object is the POI search function of the navigation system 6b. {Navigation} indicates that the operational object is the function of route guidance or map operation of the navigation system 6b. {Clock} indicates that the operational object is the function of a clock. {Help} indicates that the operational object is the help function for giving operation method for any of the apparatuses 6a to 6c, or the voice recognition device. {Ambiguous} indicates that the operational object is not clear.

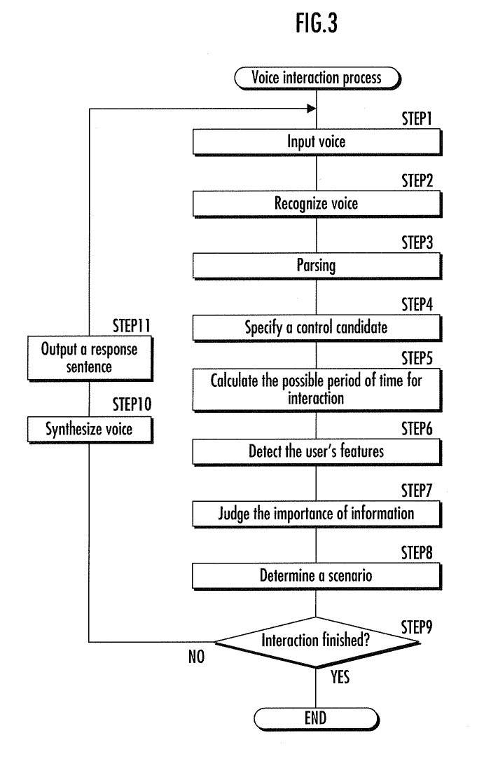

Hereinafter, an operation of the voice interaction device (voice interaction process) according to the present embodiment will be described. As illustrated in FIG. 3, firstly in STEP 1, a speech for controlling an object is input to the microphone 2 from the driver of the vehicle 10. More specifically, the driver turns ON the talk switch to instruct initiation of speech input, and inputs voice to the microphone 2.

In STEP 2, the voice interaction unit 1 performs voice recognition process to recognize the input voice and output the recognized input voice as the recognized text.

Firstly, the voice interaction unit 1 converts the voice input to the microphone 2 from analogue signals to digital signals and obtains waveform data representing the voice. Then the voice interaction unit 1 performs a frequency analysis on waveform data indicating the voice of the speech input to the microphone 2 and extracts the feature vector thereof. As such, the waveform data indicating the voice is subjected to a filtering process by for example a method of short-time spectrum analysis, and converted into a time series of feature vectors. The feature vector is an extract of a feature value of the sound spectrum at a time point, which is generally from 10 to 100 dimensions (39 dimensions for example), and a Linear Predictive Coding Mel Cepstrum coefficient or the like is used.

Next, with respect to the extracted feature vector, the voice interaction unit 1 evaluates the likelihood (sound score) of the feature vector for each of the plurality of HMMs recorded in the acoustic model 15. Then, the voice interaction unit 1 determines the phonetic data corresponding to a HMM with a high sound score among the plurality of HMMs. In this manner, when the input speech is for example “titose”, the phonetic data of “ti-to-se” is obtained from the waveform data of the voice, together with the sound score thereof. When the input speech is “mark set”, not only the phonetic data of “ma-a-ku-se-t-to” but also the phonetic data having a high degree of similarity acoustically such as “ma-a-ku-ri-su-to” are obtained together with the sound scores thereof.

Next, the voice interaction unit 1 uses the entire data in the language model 16 to determine a text expressed in a series of words from the determined phonetic data, based on the language score of the text. When a plurality of phonetic data have been determined, texts are determined for each of the plurality of phonetic data respectively.

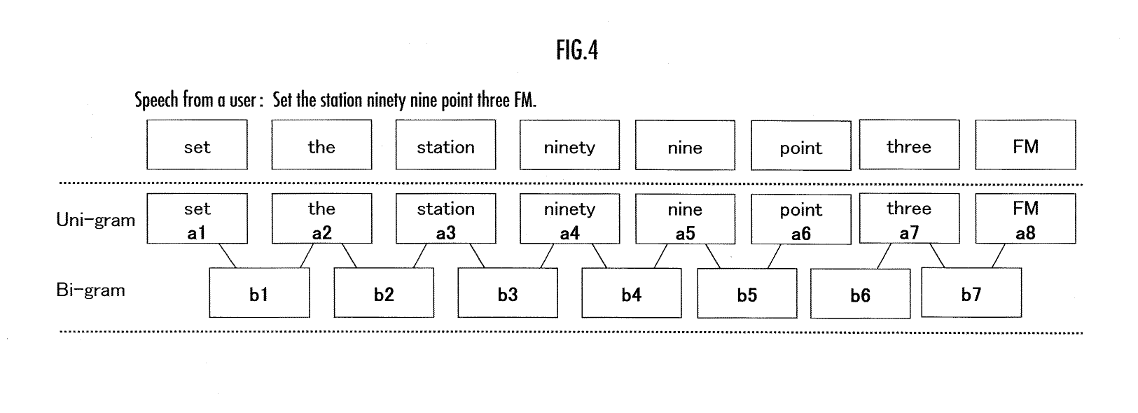

Specifically, the voice interaction unit 1 firstly compares the determined phonetic data with the phonetic data recorded in the language model 16 to extract a word with a high degree of similarity. Next, the voice interaction unit 1 calculates the language score of the extracted word, using the N-grams corresponding to the number of words included in the phonetic data. The voice interaction unit 1 then determines, for each word in the phonetic data, a text having the calculated language score fulfilling a prescribed condition (for example, not less than a predefined value). For example as illustrated in FIG. 4, in the case where the input speech is “Set the station ninety nine point three FM.”, “Set the station ninety nine point three FM” is determined as the text corresponding to the phonetic data determined from the speech.

At this time, appearance probabilities a1 to a8 of the respective words “set”, “the”, . . . , “FM” are provided in the uni-gram. In addition, occurrence probabilities b1 to b7 of the respective two-word sequences “set the”, “the station”, . . . , “three FM” are provided in the bi-gram. Similarly, for N=3 to 8, occurrence probabilities of N-word sequences c1 to c6, d1 to d5, e1 to e4, f1 to f3, g1 to g2 and h1 are provided. For example, the language score of the text “ninety” is calculated based on a4, b3, c2 and d1 obtained from the N-grams of N=1 to 4 in accordance with the number of words, four, which is the sum of the word “ninety” and the preceding three words included in the phonetic data.

Thus, the use of such a dictation method of dictating the input speech as a text using a probability and statistical language model for each word enables recognition of a spontaneous speech from the driver, not restricted to the speeches including predetermined expressions.

Next, the voice interaction unit 1 calculates, for every one of the determined texts, a weighted sum of the sound score and the language score as a confidence factor of voice recognition (voice recognition score). As a weighting factor, for example a value predetermined experimentally may be used.

Next, the voice interaction unit 1 determines and outputs the text expressed by a series of words with the calculated voice recognition score fulfilling a predefined condition as a recognized text. The predefined condition is set to be, for example, a text having the highest voice recognition score; texts having the voice recognition scores down to a predefined rank from the top; or texts having the voice recognition scores of not less than a predefined value.

Next, the voice interaction unit 1 performs parsing process to comprehend the meaning of the speech from the recognized texts in STEP 3. Specifically, the voice interaction unit 1 uses the parser model 17 to determine the categorized text from the recognized texts.

More specifically, the voice interaction unit 1 firstly uses the entire data of the parser model 17 to calculate, for each word included in the recognized text, the likelihood of a respective domain for one word. Then the voice interaction unit 1 determines the respective domain for one word according to the likelihood. In the following, the voice interaction unit 1 uses partial data categorized into the determined domain type from the entire data of the parser model 17 to calculate the likelihood of a respective class set (categorized text) for one word. And then, the voice interaction unit 1 determines the categorized text for one word based on the word score.

Similarly, the voice interaction unit 1 calculates, for a respective two-word sequence included in the recognized text, the likelihood of a respective domain for the series of two words and determines the respective domain for the two-word sequence based on the likelihood. Then, the voice interaction unit 1 calculates the likelihood (two-word score) for a respective class set (categorized text) for two-word and determines the categorized text based on the two-word score. And similarly, the voice interaction unit 1 calculates, for a respective three-word sequence included in the recognized text, the likelihood of a respective domain for the three-word sequence and determines the respective domain for the three-word sequence based on the likelihood. Then, the voice interaction unit 1 calculates the likelihood (three-word score) for a respective class set (categorized text) and determines the categorized text based on the three-word score.

Next, the voice interaction unit 1 calculates the likelihood (parsing score) of a respective class set for the entire recognized texts, based on the respective class set determined for one word, two-word sequence, and three-word sequence, and the word score (one-word score, two-word score, three-word score) of the respective class set. The voice interaction unit 1 then determines the class set (categorized text) for the entire recognized texts, based on the parsing score.

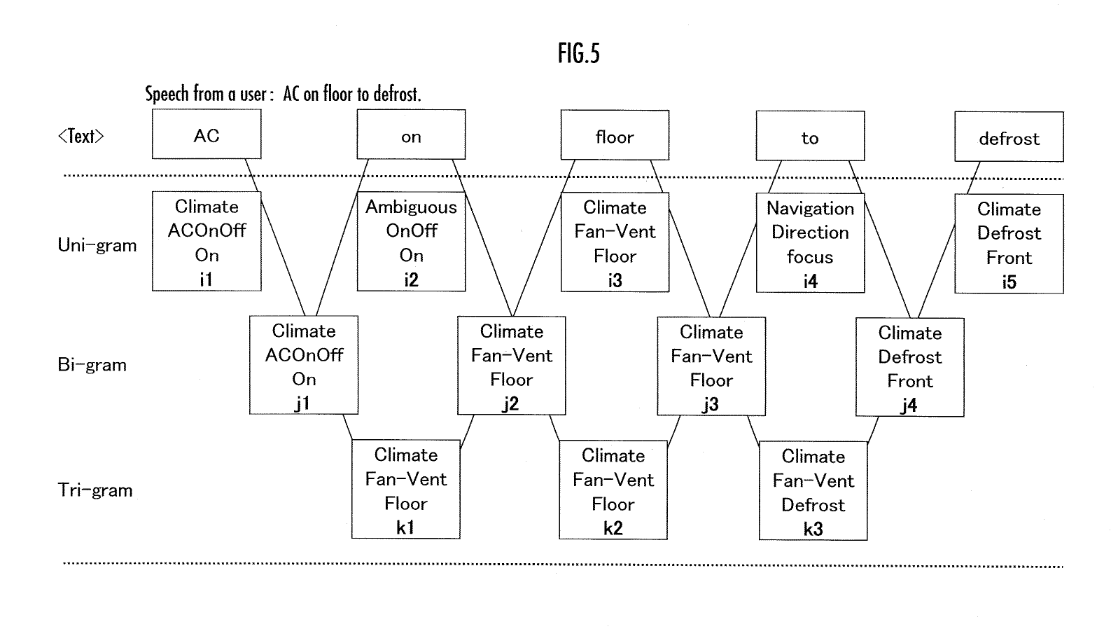

Herein, the process of determining a categorized text using the parser model 17 will be described with reference to the example illustrated in FIG. 5. In the example in FIG. 5, the recognized text is “AC on floor to defrost”.

At this time, for each of the words “AC”, “on”, . . . , “defrost”, the entire parser model 17 is used to calculate in the uni-gram the likelihood of a respective domain for one word. Then, the domain for the one word is determined based on the likelihood. For example, the domain at the top place (having the highest likelihood) is determined as {Climate} for “AC”, {Ambiguous} for “on”, and {Climate} for “defrost”.

Further, for “AC”, “on”, . . . , “defrost”, using the partial data in the parser model 17 categorized into the respective determined domain types, the likelihood of a respective class set for one word is calculated in the uni-gram. Then, the class set for the one word is determined based on the likelihood. For example, for “AC”, the class set at the top place (having the highest likelihood) is determined as {Climate_ACOnOff_On}, and the likelihood (word score) i1 for this class set is obtained. Similarly, the class sets are determined for “on”, . . . , “defrost”, and the likelihoods (word scores) i2-i5 for the respective class sets are obtained.

Similarly, for each of “AC on”, “on floor”, . . . , “to defrost”, the likelihood of a respective domain for a two-word sequence is calculated in the bi-gram, and the domain for the two-word sequence is determined based on the likelihood. Then, the class sets for the respective two-word sequences and their likelihoods (two-word scores) j1-j4 are determined. Further, similarly, the likelihood of a respective domain for a three-word sequence is calculated in the tri-gram, for each of “AC on floor”, “on floor to”, and “floor to defrost”, and the domain for the three-word sequence is determined based on the likelihood. Then, the class sets for the respective three-word sequences and the likelihoods (three-word scores) thereof k1-k3 are determined.

Next, for each of the class sets determined for one word, two-word sequence and three-word sequence, a sum of the word score(s) i1-i5, a sum of the two-word score(s) j1-j4 and a sum of the three-word score(s) k1-k3 for the corresponding class set is calculated as the likelihood (parsing score) of the class set for the entire text. For example, the parsing score for {Climate_Fan-Vent_Floor} is i3+j2+j3+k1+k2. Further, the parsing score for {Climate_ACOnOff_On} is i1+j1, and the parsing score for {Climate_Defrost_Front} is i5+j4. Then, the class sets (categorized texts) for the entire text are determined based on the calculated parsing scores. In this manner, the categorized texts such as {Climate_Defrost_Front}, {Climate_Fan-Vent_Floor} and {Climate_ACOnOff_On} are determined from the recognized text.

Next, the voice interaction unit 1 determines, based on the recognition result of the input speech, any categorized text having a calculated parsing score fulfilling the predefined condition as a control candidate, and outputs the determined control candidate together with the confidence factor (parsing score) thereof. The predefined condition is set to be, for example, a text having the highest voice recognition score; texts having the voice recognition scores down to a predefined rank from the top; or texts having the voice recognition scores of not less than a predefined value. For example, in the case where “AC on floor to defrost” is input as the input speech as described above, {Climate_Defrost_Front} will be output as a first control candidate, together with the parsing score thereof.

In STEP 4 to STEP 9, the voice interaction unit 1 determines a response to the driver or a scenario for controlling an apparatus on the basis of the control candidate group identified in STEP 3, using the data stored in the scenario database 18.

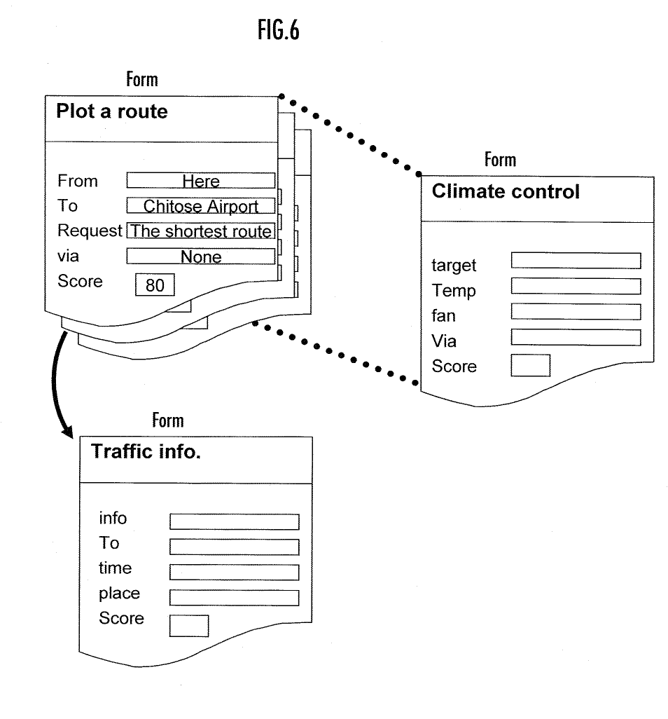

Firstly in STEP 4, the voice interaction unit 1 determines an actual control which will be performed from the identified candidates and obtains information for controlling an object thereof. As illustrated in FIG. 6, the voice interaction unit 1 is included with a plurality of forms storing information for controlling an object. In each of the plurality of forms there is provided predefined numbers of slots corresponding to necessary information classes, respectively. For example, forms such as “Plot a route”, “Traffic info.” are included as the forms storing information for controlling the navigation system 6b. A form such as “Climate control” is included as the form storing information for controlling the air conditioner 6c. In addition, the form “Plot a route” is provided with four slots of “From”, “To”, “Request” and “via”.

The voice interaction unit 1 inputs data to slots of a relevant form respectively based on the control candidates determined from the recognition result of each speech in the interaction with the driver. At the same time, a confidence factor (certainty degree for the texts input to a form) for each form will be calculated out and recorded in the form, respectively. The confidence factor of a form is calculated based on, for example, a confidence factor of a control candidate identified from a recognition result of each speech and a filling-in condition with respect to a slot of the form. For example, in the case where the speech “Please guide me to the Titose Airport by the shortest route” is input from the driver as illustrated in FIG. 6, “Titose Airport” and “the shortest route” are input to the slots “To” and “Request”, respectively, while to the slots of “From” and “via” the default data of “Here” and “none” are inputted, respectively. In addition, the slot of “Score” of the form “Plot a route” is recorded with a calculated confidence factor of 80 for the form. Then, the voice interaction unit 1 selects a form used in the actual control process to determine an operation based on the confidence factor of a form.

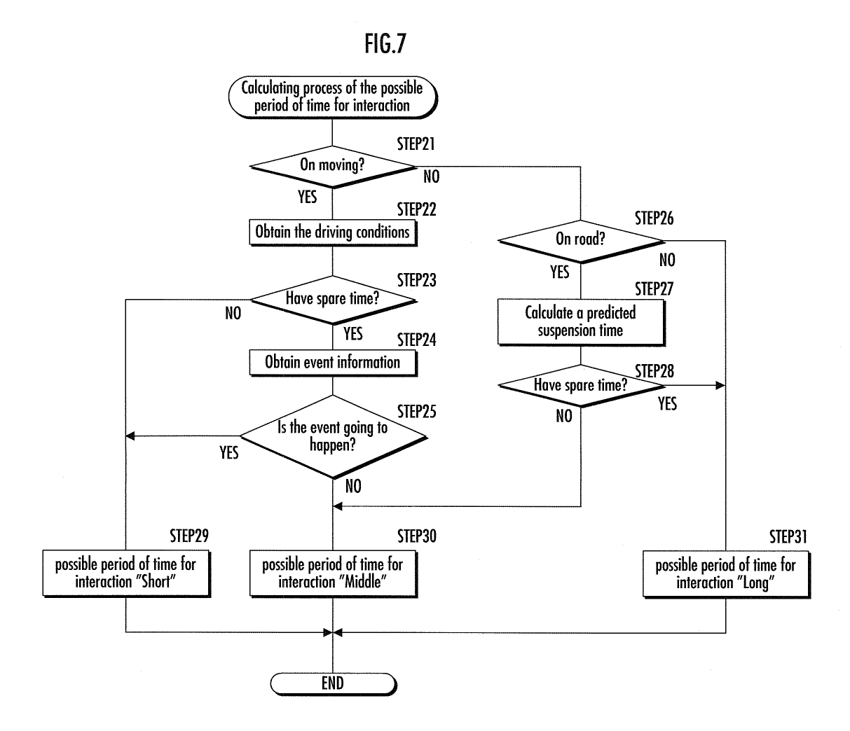

In STEP 5, the voice interaction unit 1 performs a calculation process for calculating an available period of time for interaction, based on the driving conditions of the vehicle 10 detected by the driving condition detection unit 3. The calculation process for calculating an available time for interaction is performed as illustrated with the flow chart in FIG. 7.

Referring to FIG. 7, firstly in STEP 21 the voice interaction unit 1 determines whether the vehicle 10 is running based on the detected value by the driving condition detection unit 3. If the determination result in STEP 21 is YES (that is to say, the vehicle 10 is running), the process proceeds to STEP 22 where the voice interaction unit 1 obtains the respective detected values, detected by the driving condition detection unit 3, concerning the type and width of road on which the vehicle 10 is running, the speed of the vehicle, and the inter-vehicular distance and the like. Then in STEP 23, the voice interaction unit 1 determines whether the driver has available time based on whether the detected values obtained in STEP 22 satisfy a predefined condition. If the determination result in STEP 23 is NO (meaning that the driver has no available time), the process proceeds to STEP 29 and the voice interaction unit 1 sets the available period of time for interaction to “short”.

In the case where the determination result in STEP 23 is YES (meaning that the driver has available time), the process proceeds to STEP 24 and the voice interaction unit 1 retrieves event information detected by the driving condition detection unit 3. The event information refers to information concerning specific locations of a road where the vehicle is running, such as intersection information. Next in STEP 25, the voice interaction unit 1 determines whether an event is going to happen (meaning whether an intersection or the like is in a close distance) based on a distance between the vehicle and a specific location. If the determination result in STEP 25 is YES (the intersection or the like is approaching), the process proceeds to STEP 29 and the voice interaction unit 1 sets the available period time for interaction to “short”. On the other hand, if the determination result in STEP 25 is NO (the intersection or the like is not close), the process proceeds to STEP 30 and the voice interaction unit 1 sets the available period of time for interaction to “middle”.

If the determination result in STEP 21 is NO (the vehicle 10 is not moving), the process proceeds to STEP 26 and the voice interaction unit 1 determines whether the vehicle is on road. In other words, it is determined whether the vehicle 10 is in a suspension state caused by a red traffic light, traffic jam or the like, or has been parked in a parking area or the like. If the determination result in STEP 26 is NO (that is, the vehicle 10 is not in the suspension state), the voice interaction unit 1 sets the available period of time for interaction to “long”.

In the case where the determination result in STEP 26 is YES (that is, the vehicle 10 is in the suspension state), the voice interaction unit 1 calculates a predicted suspension time based on the driving conditions detected by the driving condition detection unit 3. The predicted suspension time is a predicted period of time starting from the suspension state to an initiation of driving. Specifically, the voice interaction unit 1 calculates the predicted suspension time by obtaining the remaining time of a red light according to road-to-vehicle signals, or by obtaining the state of the preceding vehicle according to a radar or vehicle-to-vehicle communication.

In STEP 28, the voice interaction unit 1 determines whether the driver has available time based on the predicted suspension time calculated in STEP 27. In the case where the determined result in STEP 28 is NO (that is to say the driver has no available time), the process proceeds to STEP 30 and the voice interaction unit 1 sets the available period of time for interaction to “middle”. If the determined result in STEP 28 is YES (that is, the driver has available time), the process proceeds to STEP 31 and the voice interaction unit 1 the available period of time for interaction to “long”.

According to the above process, when the vehicle 10 is running and the driver has no available time, and when the vehicle 10 is running and the driver has available time however the vehicle 10 is approaching to an intersection, the voice interaction unit 1 sets the available period of time for interaction to “short”, assuming that there is less available period of time for interaction as the driver should concentrate on driving. Further, when the vehicle 10 is running and the driver has available time and the vehicle 10 is not close to an interaction, and when the vehicle 10 is in the suspension state and the driver has no available time, the voice interaction unit 1 sets the available period of time for interaction to “middle”. Furthermore, when the vehicle 10 is not moving and not on road either, and when the vehicle 10 is in the suspension state and the driver has available time, since the vehicle 10 is stopping continuously, the voice interaction unit 1 assumes that the driver may spend more time on interaction and therefore sets the available period of time for interaction to “long”. Thereby, it is possible to set appropriately the available period of time for interaction in compliance with the available time of the driver.

Again referring to FIG. 3, in STEP 6, the voice interaction unit 1 detects the features of the driver according to the operation history stored in the operation history storing unit 35. In detail, the voice interaction unit 1 uses as the level of proficiency a value which is a product of an interaction frequency between the driver and the voice interaction device and a success degree (for example the number of times of success interaction) of speech recognized successfully when an interaction is performed multiplied by a predefined coefficient factor. The value is an index indicating an adaptation level that the driver is accustomed to interaction with the voice interaction device. Then the voice interaction unit 1 categories the level of proficiency into 3 phases of “Better”, “Good” and “Poor” by comparing the same with a predefined threshold value. In addition, the voice interaction unit 1 obtains the operation number of times concerning a control identified by the recognition result of speech and sets the same as a value indicating the operation experience regarding to the control. Then the voice interaction unit 1 classifies the operation experience of the driver regarding to a specific control into 3 phases of “More”, “common” and “Less” by comparing the same with a predefined threshold value.

Next in STEP 7, the voice interaction unit 1 performs a judging process of judging the importance of information. Specifically, the voice interaction unit 1 categorizes the importance of information contained in a response stored in the scenario database 18 which is related to a control identified from the recognition result of speech into three phases of “high”, “moderate” and “low”. In STEP 7 the voice interaction unit 1 uses the importance of information preliminarily stored. For example, among traffic information, the information for accidents or the like is pre-registered with higher importance and information for weather and a non-accident traffic jam or the like is registered preliminarily with lower importance.

Furthermore, the voice interaction unit 1 adjusts the preliminarily stored importance based on the recognition result of speech, the detection value obtained from the driving condition detection unit 3 and the driver's feature detected by the user feature detection unit 33 to make a judgment on importance of information. For example, information requested by the driver via speech (request information) is adjusted to higher importance. Also for example, when the vehicle 10 is approaching to an intersection, the importance of information concerning the intersection is adjusted higher. Another example is that the importance of information regarding introduction on functions or the like will be adjusted higher so as to increase operation experience for the driver if the driver has “better” lever of proficiency but with “less” operation experience. Thereby, the importance of information is judged according to the circumferential conditions and the features of the driver.

In STEP 8, the voice interaction unit 1 determines a scenario by using the data stored in the scenario database 18. Then the voice interaction unit 1 controls an apparatus based on the determined scenario in the case where the control content of the apparatus has been specified from the recognition result of speech.

The scenario database 18 is stored with responses, which are categorized by a filling-in condition to a slot or by information contained, respectively, to be output to the driver. For example, if there is an empty slot (a slot without data filled in) in a selected form, a scenario is determined for outputting a response to prompt the driver to fill the empty slot in the form.

While in the case where all slots in the selected form are filled (all slots with data filled in, respectively), a scenario is determined for outputting a response (for example, a response to report the input data in the respective slot to the driver) to confirm the content. Also in the case where the driver is asking for information via speech, a scenario is determined for outputting a response to provide such information.

At this time, the voice interaction unit 1 determines information contained in a response to be output so as to output information with higher importance by priority on the basis of the importance of information; and information amount contained in the response to be output based on the available period of time for interaction, the lever of proficiency of the driver and the importance of information at the same time.

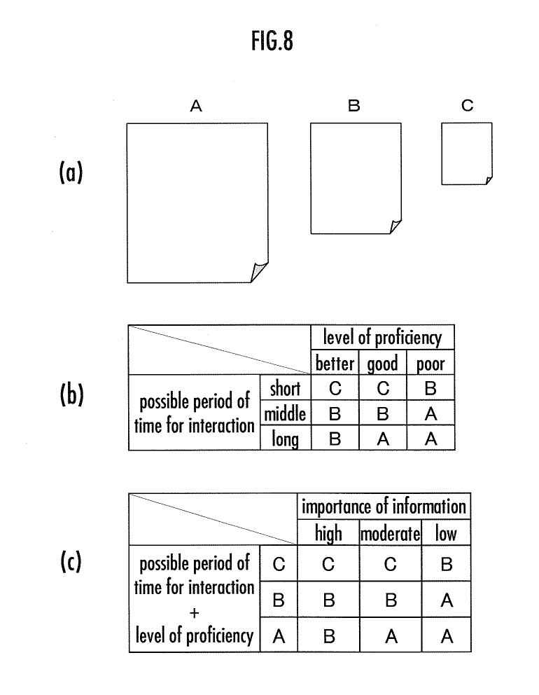

Herein, a process for determining the information amount will be described with reference to FIG. 8. As illustrated in FIG. 8(a), the information amount is preset to three phases of “A”, “B” and “C”. Firstly as illustrated in FIG. 8(b), the information amount is preset in compliance with a combination of the available period of time for interaction and the level of proficiency. In detail, in the case where the level of proficiency of the driver is “good”, the information amount is set to “A”, “B” and “C” in compliance with the available period of time for interaction of “Long”, “Middle” and “Short”. While in the case where the level of proficiency of the driver is “better”, more information amount will be set. On the other hand, in the case where the level of proficiency of the driver is “poor”, less information amount will be set.

With respect to the information amount of A, B and C set according to the combination of the available period of time for interaction and the level of proficiency, the information amount may be adjusted in compliance with the importance of information, as illustrated in FIG. 8(c). Here in FIG. 8(c), the “high”, “moderate” and “low” importance of information indicates the importance of the entire information related to a control identified from the recognition result of speech. The importance of the entire information, for example, is a percentage of the information with higher importance with respect to the information related to an operation. As illustrated in FIG. 8(c), when the importance of the entire information is “moderate”, the information amount set according to the combination of the available period of time for interaction and the level of proficiency will remain the same. While if the importance of the entire information is “high”, more information amount will be set. On the other hand, if the importance of the entire information is “low”, less information amount will be set. As a result, the information amount may be set so as to perform interaction meeting the demand of the user in an appropriate time.

In STEP 9 in FIG. 3, the voice interaction unit 1 judges whether the interaction with the driver is finished based on the determined scenario. If the judging result in STEP 9 is NO, the process proceeds to STEP 10 and the voice interaction unit 1 synthesizes a voice response according to the contents of a determined response and conditions for outputting the response. Then in STEP 11, the synthesized response (response for prompting the driver a next speech or the like) is output from the speaker 4.

The process then returns to STEP 1 and a second speech is input from the driver. Thereafter, until the judging result becomes YES in STEP 9, a process identical to that described in STEP 1 to STEP 11 on the second speech are repeated.

The voice interaction process ends when the judging result in STEP 9 is YES. At this time, if a scenario for reporting to a user a completion of an apparatus control or the like has been determined, the voice interaction unit 1 outputs via the speaker 4 a response sentence (such as a response sentence reporting the completion of the apparatus control to the user) in accordance with the content of the determined response sentence as well as the conditions for outputting the response sentence.

According to the processes described above, it is possible to perform an interaction satisfying the user's demand in appropriate time in flexible response to the user's conditions.

### INTERACTION EXAMPLES

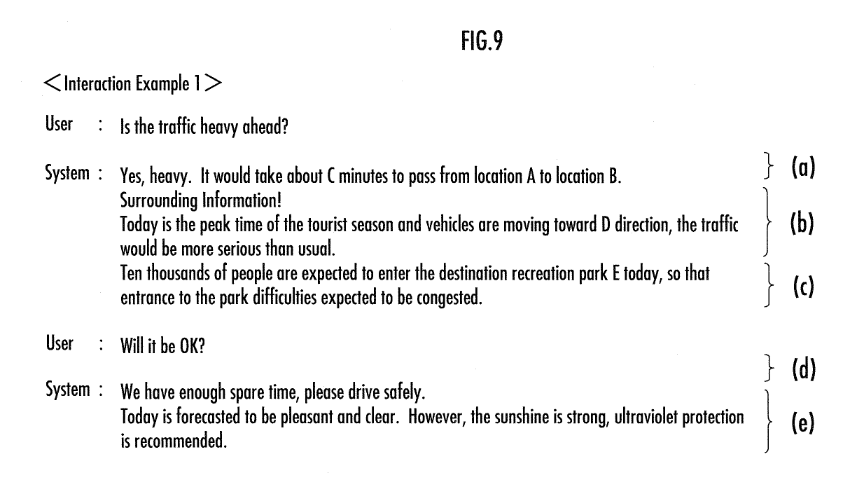

Hereinafter, the voice interaction process described above will be explained in detail with the interaction examples 1 to 3 illustrated in FIGS. 9 to 11, respectively. Each of the interaction examples 1 to 3 illustrates a case where the user (for example, the driver) is inquiring traffic information by controlling the navigation system 6b via the interaction with the system, i.e., the voice interaction device.

### Interaction Example 1

The interaction example 1 illustrated in FIG. 9 will be explained. The interaction example 1 is an example illustrating a situation where the user is has “long” available time, “better” level of proficiency in interaction with the device and “more” operation experience.

Firstly, as illustrated in STEP 1 of FIG. 3, “Is the traffic heavy ahead?” from the user is input as the first time speech. Then in STEP 2, the recognized text is obtained by the voice recognition process; in STEP 3 the control candidate corresponding to the meaning of the recognized text by the parsing process is obtained; and in STEP 4 the control which will be performed actually (for example, to provide the traffic information) is identified or specified.

In STEP 5, the available period of time for interaction is calculated as “long”, and in STEP 6 the level of proficiency and the operation experience of the user are detected as “better” and “more”, respectively. Then in STEP 7, together with the extraction of information related to traffic information supply, the priorities for respective information are judged. In addition, the importance of the entire traffic information is set to “moderate”.

In STEP 8, the information contained in the output and the amount thereof are determined. At this time as the available period of time for interaction is “long”, the level of proficiency is “better”, and the importance of the entire information is “moderate”, the information amount has been determined with the most “A”. Therefore it is possible to output more information at this time; in addition to the response sentence (FIG. 9(a)) corresponding directly to the information required by the user via speech, a scenario is determined to output as related information the response sentence concerning the cause for traffic jam (FIG. 9(b)) and the response sentence concerning congestion of the destination (FIG. 9(c)). In the following, the response sentences are voice synthesized in STEP 10 and the synthesized voice is output from the speakers 4 in STEP 11.

Then the process returns to STEP 1, another speech “Will it be OK?” is input from the user, and another control candidate is specified from the recognition result of the speech in STEP 2 to STEP 4. Similar to the first time speech, the available period time for interaction is calculated as “long” in STEP 5, the level of proficiency is detected as “better” and the importance of the entire information is detected as “moderate” in STEP 6. Thereafter in STEP 7, together with the extraction of information related to traffic information supply, the priorities for information respectively are judged.

In STEP 8, similar to the first time speech, the information amount is determined with the most “A”. Therefore it is possible to output more information at this time; in addition to the response sentence (FIG. 9(d)) corresponding directly to the information required by the user via speech, a scenario is determined to output the response sentence concerning the weather (FIG. 9(e)) as the related information. Then in STEP 9 the interaction is determined to be finished, the response sentences are voice synthesized and the synthesized voice is output from the speakers 4 in STEP 11. The voice interaction process is ended.

Thus, in the case where the user has “long” available time, “better” level of proficiency and “more” operation experience, the voice interaction control is performed to provide more related information, together with the output of the required information in brief.

### Interaction Example 2

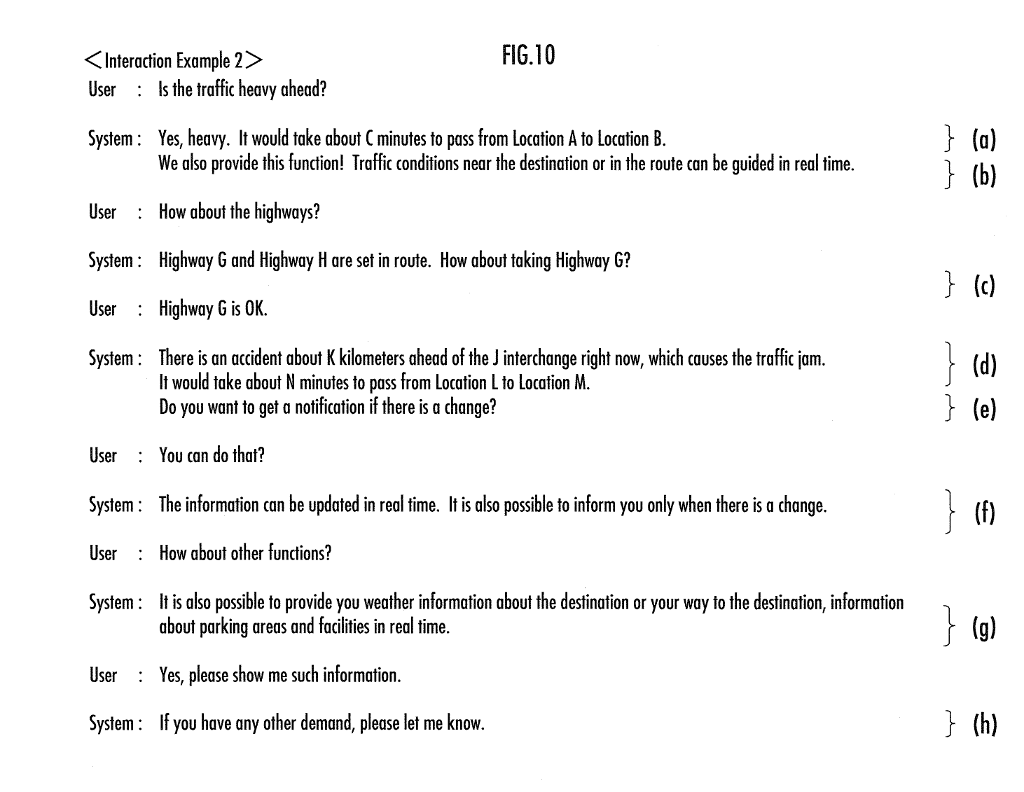

The interaction example 2 as illustrated in FIG. 10 will be explained. The interaction example 2 illustrates a case where the user has “long” available time, “better” level of proficiency but “less” operation experience.

Firstly, as illustrated in STEP 1 of FIG. 3, similar to the interaction example 1, “Is the traffic heavy ahead?” from the user is input as the first time speech. Then the control candidate is specified from the recognition result of the speech through STEP 2 to STEP 4.

Then the available period time for interaction is calculated as “long” in STEP 5, and the level of proficiency is detected as “better” and the operation experience of the driver is detected as “less” in STEP 6. Thereafter in STEP 7, together with the extraction of information related to traffic information supply, the priorities for respective information are judged. Herein, for the driver who has “better” level of proficiency but “less” operation experience, in order to increase the operation experience for the driver, the importance of the related information such as introduction on functions or the like will be adjusted higher.

In STEP 8, the information contained in the output and the information amount are determined. Herein, since the available period of time for interaction is “long”, the level of proficiency is “better”, and the importance of the entire information is “moderate”, the information amount has been determined with the most “A”. Therefore it is possible to output more information at this time; in addition to the response sentence (FIG. 10(a)) corresponding directly to the information required by the user via speech, a scenario is determined to output as the related information the response sentences concerning the introduction on functions whose importance is relatively set higher (FIG. 10(b)). Thereafter, the response sentences are voice synthesized in STEP 10 and the synthesized voice is output from the speakers 4 in STEP 11.

Then the process returns to STEP 1, another speech is input from the user, the process similar to that of STEP 1 to STEP 11 is repeated, the voice interaction is performed and the response sentences as illustrated in FIG. 10(c) to FIG. 10(g) are output. Finally, the voice interaction is determined to be finished in STEP 9, the response sentences illustrated in FIG. 10(h) are voice synthesized and the synthesized voice is output from the speakers 4. The voice interaction process is ended.

Thus, in the case where the user has “long” available time, “better” level of proficiency but “less” operation experience, the voice interaction control is performed to do more conversations such as providing the introduction on functions as illustrated in FIGS. 10(b) and 10(c), so as to increase the operation experience of the user.

### Interaction Example 3

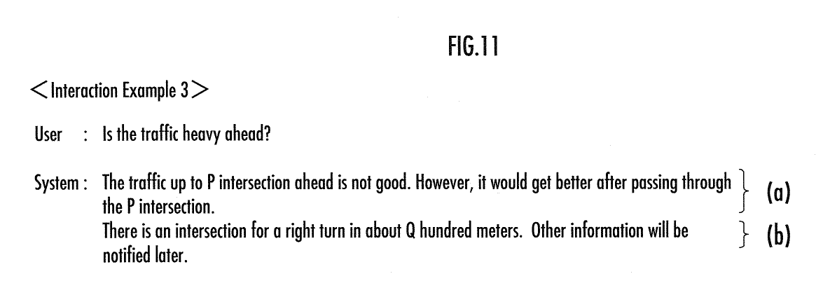

The interaction example 3 illustrated in FIG. 11 will be explained. The interaction example 3 is an example illustrating a situation where the user is approaching an intersection and has “short” available time, “good” level of proficiency in interaction with the device and “common” operation experience.

Firstly, as illustrated in STEP 1 of FIG. 3, similar to the interaction example 1, “Is the traffic heavy ahead?” from the user is input as the first time speech. Then the control candidate is specified from the recognition result of the speech through STEP 2 to STEP 4.

Then the available period time for interaction is calculated as “short” in STEP 5, and the level of proficiency is detected as “good” and the operation experience is detected as “common” in STEP 6. Thereafter in STEP 7, together with the extraction of information related to traffic information supply, the priorities for respective information are judged. Herein, since the intersection is close, the importance of the information concerning the intersection is adjusted higher.

In STEP 8, the information contained in the output and the information amount are determined. Herein, since the available period of time for interaction is “short”, the level of proficiency is “poor”, and the importance of the entire information is “moderate”, the information amount has been determined with the least “C”. Therefore it is only possible to output less information at this time, a scenario is determined to output the response sentence (FIG. 11(a)) corresponding directly to the information required by the user via speech, and the response sentence concerning the intersection whose importance is highly set (FIG. 11(b)). Finally, the voice interaction is determined to be finished in STEP 9, the response sentences are voice synthesized and the synthesized voice is output from the speakers 4. The voice interaction process is ended.

Thus, in the case where the user has “short” available time, the voice interaction control is performed to provide the information with high importance in brief.

As illustrated in the above interaction examples 1 to 3, with respect to the same first time speech, the interaction may be controlled in flexible response to the conditions of the user, thus the necessary information is provided via the interaction with good efficiency.

It should be noted that in the present embodiment, the available time calculation unit 32, the user feature detection unit 33, the importance judging unit 34 and the interaction control unit 31 are configured to set the available period of time for interaction, the user features, the importance of information and the information amount to three phases, respectively; however, they may be arbitrarily set to two phases, 4 phases or more, respectively. In addition they may also be set to vary continuously, respectively.

In addition, in the present embodiment, the user feature detection unit 33 is configured to detect the level of proficiency and operation experience of a predefined control as the driver's features, the importance judging unit 34 and the interaction control unit 31 judge the priority of information by using the driver's feature and determine the information amount contained in the response sentences to be output; however, a driver's preference or the like for the interaction or a predefined control may be detected and used as the driver's features as well.

Also in the present embodiment, the input speech is recognized by the dictation method of dictating the input speech as a text using a probability and statistical language model for each word; however it is also preferable to recognize the input speech by using a voice recognition dictionary with words as the recognition objects registered preliminarily.

In the present embodiment, the user who performs the voice input is configured to be the driver; however, the voice input may also be performed by an occupant other than the driver.

The voice interaction device is described as mounted to the vehicle 10. It is possible for the voice recognition device to be mounted to a movable object other than the vehicle. Furthermore, not limited to a movable object, it is possible for the voice recognition device to be applied in any system where a user controls an object via voice input. In this case, the motion state (for example, during walking), the time of interaction in a day and the like, for example may be taken as the circumferential conditions of the user. Although the present invention has been explained in relation to the preferred embodiments and drawings but not limited, it is to be understood that other possible modifications and variations made without departing from the spirit and scope of the invention will be comprised in the present invention. Therefore, the appended claims encompass all such changes and modifications as falling within the gist and scope of the present invention.

What is claimed is:

1. A voice interaction device which controls an interaction in response to a voice input from a user, comprising:
an available time calculation unit which calculates an available period of time for interaction with the user based on a circumferential condition of the user, and
an interaction control unit which controls interaction based on at least the available period of time for interaction calculated by the available time calculation unit.

2. The voice interaction device as claimed in claim 1, wherein:
the user is an occupant of a vehicle;
the voice interaction device is mounted to the vehicle and further includes a driving condition detection unit which detects a driving condition of the vehicle; and
the available time calculation unit employs the driving condition detected by the driving condition detection unit as the circumferential condition of the user to calculate the available period of time for interaction with the user.

3. The voice interaction device as claimed in claim 2, wherein the driving condition includes at least one of information concerning running road of the vehicle, information concerning a running condition of the vehicle, and information concerning an operation condition of an apparatus mounted to the vehicle.

4. The voice interaction device as claimed in claim 1, wherein the voice interaction device further includes a user feature detection unit which detects a feature of the user interacting with the voice interaction device, and the interaction control unit controls interaction based on the feature of the user detected by the user feature detection unit.

5. The voice interaction device as claimed in claim 4, wherein the user feature detection unit detects the feature of the user based on an interaction history of the voice interaction by the user.

6. The voice interaction device as claimed in claim 4, wherein the user feature detection unit detects a level of proficiency in the interaction between the voice interaction device and the user as the feature of the user.

7. The voice interaction device as claimed in claim 1, wherein the voice interaction device further includes an importance judging unit which judges importance of information output to the user under interaction control by the interaction control unit, and the interaction control unit controls interaction based on a judging result from the importance judging unit.

8. A voice interaction method which controls an interaction in response to a voice input from a user, comprising:
an available time calculation step of calculating an available period of time for interaction with the user based on a circumferential condition of the user, and
an interaction control step of controlling interaction based on at least the available period of time for interaction calculated in the available time calculation step.

9. A voice interaction program causing a computer to execute a process of controlling an interaction in response to a voice input from a user, having function to cause the computer to execute:
an available time calculation process of calculating an available period of time for interaction with the user based on a circumferential condition of the user, and
an interaction control process of controlling interaction based on at least the available period of time for interaction calculated in the available time calculation process.
